(19) United States
(12) Patent Application Publication
(10) Pub. No.: US 2023/0093928 A1
(43) Pub. Date: Mar. 30, 2023

(54) ATTACHMENT, SOLID-PHASE PARTICLE COLLECTION DEVICE, AND SOLID-PHASE PARTICLE COLLECTION SYSTEM

(71) Applicant: TATSUTA ELECTRIC WIRE & CABLE CO., LTD., Osaka (JP)

(72) Inventor: Masaki HIRANO, Kyoto (JP)

(21) Appl. No.: 17/801,626

(22) PCT Filed: Feb. 26, 2021
(86) PCT No.: PCT/JP2021/007230

§ 371 Date: Aug. 23, 2022

(30) Foreign Application Priority Data
Feb. 26, 2020 (JP) 2020-030863

(51) Int. Cl. B05B 14/10; C23C 24/04; B05B 1/28; B05B 12/32

(52) U.S. Cl. CPC B05B 14/10; C23C 24/04; B05B 1/28; B05B 12/32

(57) ABSTRACT

Even in a case where a spray nozzle of a solid phase particle deposition device is in motion, flying solid phase particles are efficiently collected. An attachment (1) includes: an engagement part (2) to be engaged with a spray nozzle (130) of a cold spray device (1); and an opening part (3) connected to the engagement part (2) and having at least one opening (3a, 3b) to be connected to a collection section (20) that is configured to collect solid phase particles (30b) which are sprayed through the spray nozzle (130) onto a base material (170) and are not involved in formation of a film on the base material (170).

### TECHNICAL FIELD

The present invention relates to an attachment, a solid phase particle collection device, and a solid phase particle collection system each of which is used in a solid phase particle deposition device.

### BACKGROUND ART

A solid phase particle deposition method is known as a technique of spraying solid phase particles (powder) onto a base material to form a film on the base material. The solid phase particle deposition method includes, for example, a cold spray method.

The cold spray method is a technique for accelerating powder with high-pressure gas to form a film on a base material. After collision with the base material, the powder that has not form a film can have the following adverse effects: (1) adhesion to the periphery of the base material; (2) adhesion to an inner wall of a chamber; (3) adhesion to surrounding parts and the like; and/or (4) flying to the outside due to opening and closing of the chamber. A method for collecting flying powder during film formation is disclosed in, for example, Patent Literature 1.

### CITATION LIST

### Patent Literature

### Patent Literature 1

Japanese Patent Application Publication Tokukai No. 2003-119673 (Publication date: Apr. 23, 2003)

### SUMMARY OF INVENTION

### Technical Problem

Patent Literature 1 discloses a suction member that sucks an aerosol that is not involved in the formation of a structure after the aerosol has collided with a base material.

However, in Patent Literature 1, a spray nozzle is not in motion, and a suction cylinder is not attached to the spray nozzle (see FIG. 3). Thus, the technique of Patent Literature 1 has a problem that flying powder is not collected from the suction cylinder in a case where the spray nozzle is in motion.

An aspect of the present invention has been made in view of the above-described problem, and an object thereof is to provide an attachment, a solid phase particle collection device, and a solid phase particle collection system each of which is capable of efficiently collecting flying solid phase particles even in a case where a spray nozzle of a solid phase particle deposition device is in motion.

### Solution to Problem

In order to solve the above-described problem, an attachment in accordance with an aspect of the present disclosure includes: an engagement part to be engaged with a spray nozzle of a solid phase particle deposition device; and an opening part connected to the engagement part and having at least one opening to be connected to a collection section that is configured to collect solid phase particles which are sprayed through the spray nozzle onto a base material and are not involved in formation of a film on the base material.

In order to solve the above-described problem, a solid phase particle collection device in accordance with an aspect of the present disclosure is a solid phase particle collection device for use in a solid phase particle deposition device, including: an attachment set to a spray nozzle of the solid phase particle deposition device and having an opening; and a collection section connected to the opening and configured to collect, via the opening, solid phase particles which are sprayed through the spray nozzle onto a base material and are not involved in formation of a film on the base material.

In order to solve the above-described problem, a solid phase particle collection system in accordance with an aspect of the present disclosure includes: an attachment set to a spray nozzle of a solid phase particle deposition device and having an opening; a collection section connected to the opening and configured to collect, via the opening, solid phase particles which are sprayed through the spray nozzle onto a base material and are not involved in formation of a film on the base material; and a guide member provided on the base material and configured to guide the solid phase particles toward the opening.

### Advantageous Effects of Invention

According to an aspect of the present disclosure, it is possible to efficiently collect flying solid phase particles even in a case where a spray nozzle of a solid phase particle deposition device is in motion.

### BRIEF DESCRIPTION OF DRAWINGS

FIG. 1 is a side view schematically illustrating a solid phase particle collection system in accordance with an embodiment of the present invention.

FIG. 2 is a view schematically illustrating a cold spray device in accordance with an embodiment of the present invention.

FIG. 3 is a photograph illustrating an example of a jig in accordance with an embodiment of the present invention.

FIG. 4 is a photograph illustrating another example of the jig in accordance with an embodiment of the present invention.

FIG. 5 is a view schematically illustrating a positional relationship between a spray nozzle and a base material.

FIG. 6 is a view illustrating a state in which solid phase particles fly from the spray nozzle.

FIG. 7 is a view illustrating a state in which the solid phase particles are collected.

FIG. 8 is a view illustrating a state in which the jig is provided on the base material, in accordance with an embodiment of the present invention.

FIG. 9 is a view illustrating an example of the shape of the jig in accordance with an embodiment of the present invention.

### DESCRIPTION OF EMBODIMENTS

Embodiments are described below with reference to the drawings. In the following description, identical components and identical constituent elements are given respective identical reference signs. Such components and constituent elements are also identical in name and function. Thus, a specific description of those components and constituent elements is not repeated.

An embodiment of the present invention can be applied to a solid phase particle deposition device. The solid phase particle deposition device includes, for example, cold spraying or aerosol deposition. The description of an embodiment of the present invention takes cold spraying as an example.

[Cold Spraying]

In recent years, a film forming method, that is called “cold spraying”, has been used. The cold spraying is a method for (i) causing a carrier gas whose temperature is lower than a melting point or a softening temperature of a film material (solid phase particles) to flow at a high speed, (ii) introducing the solid phase particles into the flow of the carrier gas so as to increase the speed of the carrier gas into which the solid phase particles have been introduced, and (iii) causing the solid phase particles to collide with, for example, a base material at a high speed while the solid phase particles are in a solid phase so as to form a film.

A principle of film formation by the cold spraying is understood as below.

A collision speed of not less than a certain critical value is required for solid phase particles to adhere to and accumulate on a base material so as to form a film on the base material. Such a collision speed is referred to as a critical speed. In a case where the solid phase particles collide with the base material at a speed that is lower than the critical speed, the base material is worn, so that small crater-shaped cavities are merely formed in the base material. The critical speed is changed in accordance with, for example, a material, a size, a shape, a temperature, and/or an oxygen content of the solid phase particles, or a material of the base material.

In a case where the solid phase particles collide with the base material at a speed that is not less than the critical speed, plastic deformation caused by a great shearing force occurs near an interface between the solid phase particles and the base material (or the film which has already been formed). The plastic deformation and generation of a great shock wave in a solid due to the collision cause an increase in temperature near the interface, and in this process, solid phase bonding occurs (i) between the solid phase particles and the base material and (ii) between the solid phase particles and the film (or the solid phase particles which have already adhered to the base material).

(Cold Spray Device 100)

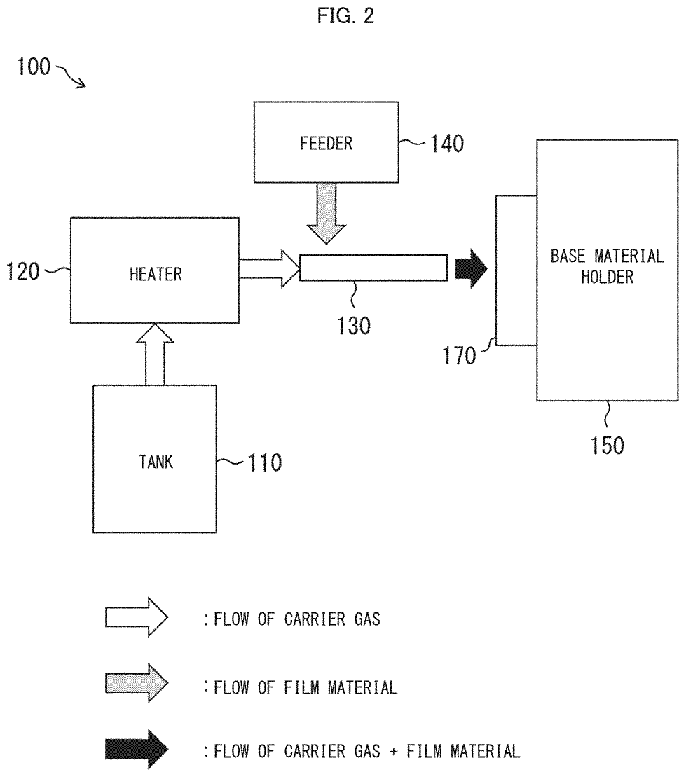

FIG. 2 is a view schematically illustrating the cold spray device 100. As illustrated in FIG. 2, the cold spray device 100 includes a tank 110, a heater 120, a spray nozzle 130, a feeder 140, a base material holder 150, and a control device (not illustrated).

The tank 110 stores therein a carrier gas. The carrier gas is supplied from the tank 110 to the heater 120. Examples of the carrier gas include nitrogen, helium, air, and a mixed gas of nitrogen, helium, and air. A pressure of the carrier gas is adjusted so that the pressure of the carrier gas at the exit of the tank 110 is, for example, not less than 70 PSI and not more than 150 PSI (not less than approximately 0.48 Mpa and not more than approximately 1.03 Mpa). Note, however, that the pressure of the carrier gas at the exit of the tank 110 does not necessarily need to fall within the above range, and such pressure is appropriately adjusted in accordance with, for example, material(s) and/or a size of solid phase particles, or material(s) of a base material.

The heater 120 heats the carrier gas which has been supplied from the tank 110. More specifically, the carrier gas is heated to a temperature that is lower than a melting point of the solid phase particles which are supplied from the feeder 140 to the spray nozzle 130. For example, the carrier gas is heated so that the temperature of the carrier gas at an exit of the heater 120 falls within the range of not less than 50° C. and not more than 500° C. Note, however, that a heating temperature of the carrier gas at the exit of the heater 120 does not necessarily need to fall within the above range, and is appropriately adjusted in accordance with, for example, the material(s) and/or the size of the solid phase particles, or the material(s) of the base material.

The carrier gas is heated by the heater 120 and is then supplied to the spray nozzle 130.

The spray nozzle 130 (i) accelerates a speed of the carrier gas which has been heated by the heater 120 so that the speed falls within the range of not less than 300 m/s and not more than 1200 m/s, and then (ii) sprays the carrier gas therethrough onto a base material 170. Note, however, that the speed of the carrier gas does not necessarily need to fall within the above range, and is appropriately adjusted in accordance with, for example, the material(s) and/or the size of the solid phase particles, or the material(s) of the base material.

The feeder 140 supplies the solid phase particles to the flow of the carrier gas whose speed is accelerated by the spray nozzle 130. The solid phase particles which are supplied from the feeder 140 have a particle size of, for example, not less than 1 μm and not more than 50 μm. Together with the carrier gas, the solid phase particles which have been supplied from the feeder 140 are sprayed through the spray nozzle 130 onto the base material 170.

The base material holder 150 fixes the base material 170. Onto the base material 170 which has been fixed by the base material holder 150, the carrier gas and the solid phase particles are sprayed through the spray nozzle 130. A distance between a surface of the base material 170 and a tip of the spray nozzle 130 is adjusted so that the distance falls within the range of, for example, not less than 1 mm and not more than 30 mm. In a case where the distance between the surface of the base material 170 and the tip of the spray nozzle 130 is less than 1 mm, a spraying speed at which the solid phase particles are sprayed is decreased. This is because the carrier gas sprayed from the spray nozzle 130 flows back into the spray nozzle 130. During the flowing back, a pressure generated when the carrier gas flows back can cause a member (e.g., a hose) connected to the spray nozzle 130 to be detached from the spray nozzle 130. Note, however, that in a case where the distance between the surface of the base material 170 and the tip of the spray nozzle 130 is more than 30 mm, efficiency in film formation is decreased. This is because it becomes more difficult for the carrier gas and the solid phase particles which have been sprayed from the spray nozzle 130 to reach the base material 170.

Note, however, that the distance between the surface of the base material 170 and the tip of the spray nozzle 130 does not necessarily need to fall within the above range, and is therefore appropriately adjusted in accordance with, for example, the material(s) and/or the size of the solid phase particles, or the material(s) of the base material.

The control device controls the cold spray device 100 in accordance with information stored therein in advance and/or an input by an operator. More specifically, the control device controls, for example, (i) the pressure of the carrier gas which is supplied from the tank 110 to the heater 120, (ii) the temperature of the carrier gas which is heated by the heater 120, (iii) a kind and an amount of the solid phase particles which are supplied from the feeder 140, and (iv) the distance between the surface of the base material 170 and the spray nozzle 130.

The cold spray device 100 may use well-known solid phase particles in order to perform the cold spraying. For example, a material such as nickel powder, tin powder, or a mixed material of tin powder and zinc powder can be used as solid phase particles.

The use of the cold spray device 100 allows enjoying advantages of cold spraying. The cold spraying brings about, for example, the following advantages: (1) prevention of oxidization of a film, (2) prevention of a change in quality of a film by heat, (3) formation of a dense film, (4) prevention of generation of fumes, (5) minimum masking, (6) film formation achieved by a simple device, and (7) formation of a thick metal film achieved in a short period of time.

(Solid Phase Particle Collection System)

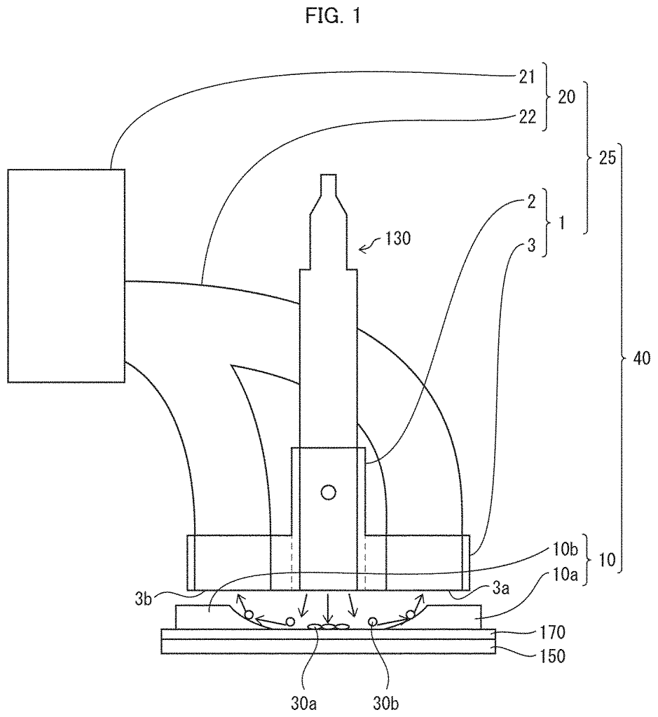

The following will describe a solid phase particle collection system 40 in accordance with an embodiment of the present invention with reference to FIG. 1. FIG. 1 is a side view schematically illustrating the solid phase particle collection system 40 in accordance with an embodiment of the present invention.

The solid phase particle collection system 40 is a system for collecting flying solid phase particles, which are not involved in the film formation on the base material 170, in the cold spray device 100 (solid phase particle deposition device). The solid phase particle collection system 40 includes a jig 10 (guide member) and a solid phase particle collection device 25. The solid phase particle collection device 25 includes an attachment 1 and a collection section 20.

The attachment 1 is constituted by an engagement part 2 and an opening part 3. The engagement part 2 and the opening part 3 may be provided integrally. In a case where the engagement part 2 and the opening part 3 are provided integrally, no clear boundary is present between the engagement part 2 and the opening part 3. However, in the attachment 1, a connection between two different parts that have different functions can be considered to be a connection between the engagement part 2 and the opening part 3.

The engagement part 2 and the opening part 3 may be provided as separate members and connected to each other. In a case where the engagement part 2 and the opening part 3 are provided as separate members, the engagement part 2 and the opening part 3 may be detached by any method. For example, the opening part 3 has a hole corresponding to the outer shape of the engagement part 2 so that the engagement part 2 is fitted into the hole.

The engagement part 2 is engaged with the spray nozzle 130. The engagement part 2 may be engaged with the spray nozzle 130 by any method. For example, the engagement part 2 is engaged with the spray nozzle 130 by a method such as screwing, fitting, or bolting.

The opening part 3 has one or more openings. In FIG. 1, the opening part 3 has two openings 3a and 3b. The openings 3a and 3b each have any shape that enables the openings 3a and 3b to be connected to a hose 22 (described later). Preferably, the opening 3a is located above a jig 10a (described later), and the opening 3b is located above a jig 10b (described later).

The openings 3a and 3b are preferably positioned near the tip of the spray nozzle 130. Being positioned near the tip means that opening centers of the openings 3a and 3b are positioned at respectively corresponding positions that are not less than 5 mm and not more than 30 mm away from respectively corresponding side surfaces of the spray nozzle 130 in a lateral direction and that are at a height of not less than 5 mm and not more than 20 mm above the base material 170. This makes it possible to enhance the efficiency in collecting the solid phase particles 30b. The lateral direction refers to a direction that is parallel to a main surface of the base material 170 on which a film is to be formed. The opening centers refer to respectively corresponding centers of circles in a case where the openings 3a and 3b are circular, and refer to respectively corresponding intersections of diagonal lines in a case where the openings 3a and 3b are square or rectangular.

The collection section 20 includes a dust collector 21 and a hose 22. The dust collector 21 collects, via the openings 3a and 3b, the solid phase particles 30b that are sprayed through the spray nozzle 130 onto the base material 170 and are not involved in the film formation on the base material 170.

The dust collector 21 preferably has the ability to collect dust at an airflow rate that is equal to or higher than a predetermined airflow rate. In a case where the dust collector 21 has the ability to collect dust at an airflow rate that is equal to or higher than a predetermined airflow rate, it is possible for the dust collector 21 to enhance the efficiency in collecting the solid phase particles 30b. In a case where the dust collector 21 has the ability to collect dust at an airflow rate that is lower than the predetermined airflow rate, the efficiency in collecting the solid phase particles 30b decreases. The predetermined airflow rate is determined according to, for example, the shape of the openings 3a and 3b, the distance between the openings 3a and 3b and the base material 170, and/or the pressure of the carrier gas. The dust collector 21 may be realized by any other configuration (such as a cyclone or static electricity) capable of collecting the solid phase particles 30b.

The hose 22 has a first end that is connected to the openings 3a and 3b, and has a second end that differs from the first end and that is connected to the dust collector 21. The hose 22 is connected to the openings 3a and 3b and/or the dust collector 21 by a method such as screwing or fitting. The hose 22 may be of any material and/or shape.

The jig 10 is fixed to the base material 170. Alternatively, the jig 10 is detachably provided on the base material 170. The jig 10 includes one or more jigs. The jig 10 rectifies the flow of the carrier gas sprayed through the spray nozzle 130 and guides the solid phase particles 30b toward the openings 3a and 3b. The jig 10 preferably extends along a direction in which the spray nozzle 130 moves. A material of the jig 10 is not limited, provided that the material exhibits the above functions.

In the example illustrated in FIG. 1, the jig 10 includes a jig 10a and a jig 10b. The jig 10a and the jig 10b are provided on the base material 170 and guide the solid phase particles 30b toward the openings 3a and 3b, respectively. In the following description, in a case where the jigs 10a and 10b (described later) are not distinguished, the jigs 10a and 10b are referred to simply as jigs 10.

The solid phase particles 30a are solid phase particles that have been involved in the film formation on the base material 170. The solid phase particles 30b are solid phase particles that have not been involved in the film formation on the base material 170.

(Jig)

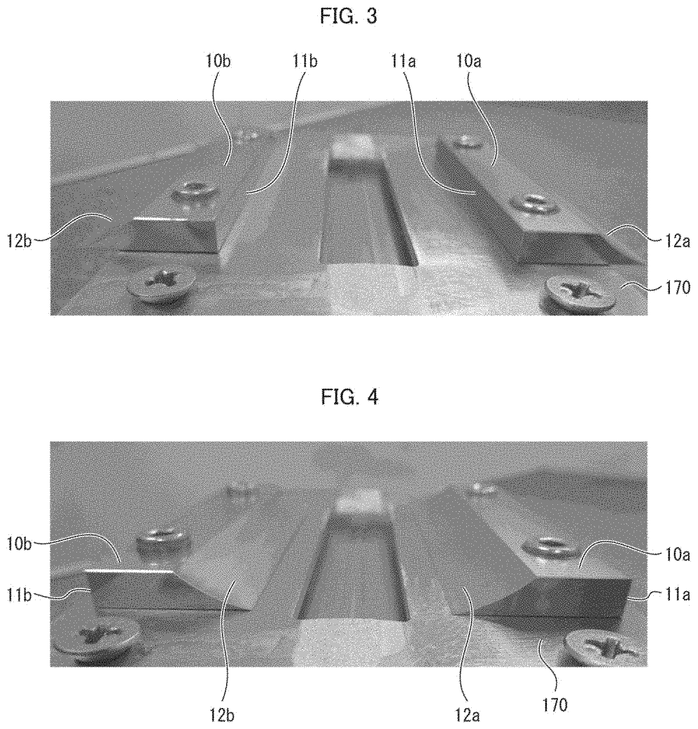

FIG. 3 is a photograph illustrating an example of the jig 10 in accordance with an embodiment of the present invention. As illustrated in FIG. 3, the jig 10a and the jig 10b are provided on the base material 170. The jig 10a and the jig 10b extend along the direction in which the spray nozzle 130 (not illustrated) moves.

The jig 10a has a surface 11a perpendicular to the base material 170 and has a surface 12a formed in the shape of an arc. The jig 10b has a surface 11b perpendicular to the base material 170 and has a surface 12b formed in the shape of an arc. In FIG. 3, the surfaces 11a and 11b are provided on a spray nozzle 130 side.

FIG. 4 is a photograph illustrating another example of the jig 10 in accordance with an embodiment of the present invention. In FIG. 4, the surface 12a and the surface 12b are provided on the spray nozzle 130 side.

FIGS. 3 and 4 merely illustrate examples, and the jig 10 may be configured in other shapes. Other examples of the shape of a cross section of the jig 10 include a square shape, a rectangular shape, a triangular shape, and a circular shape.

(Collection of Solid Phase Particles)

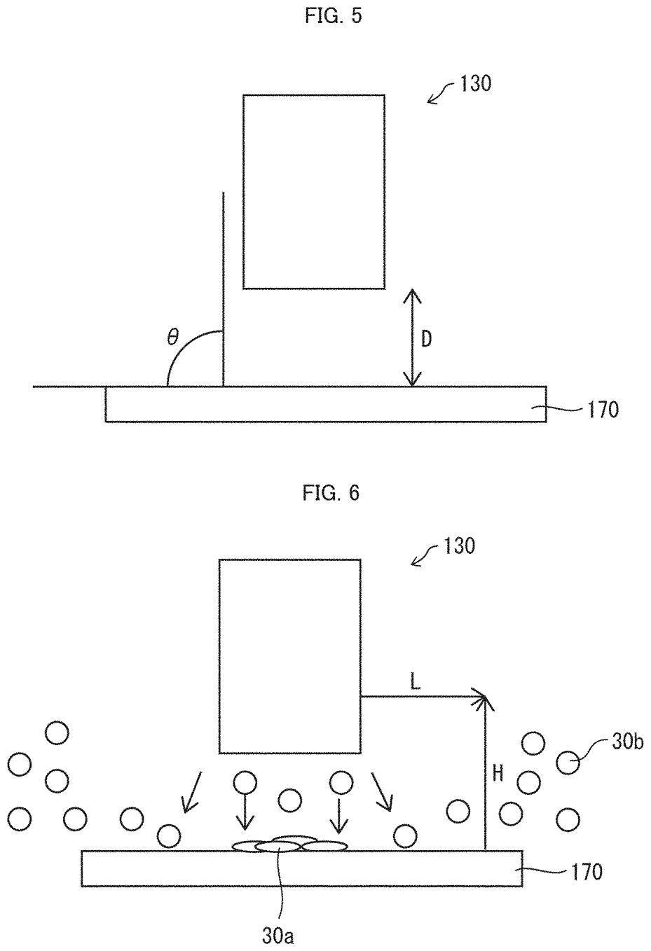

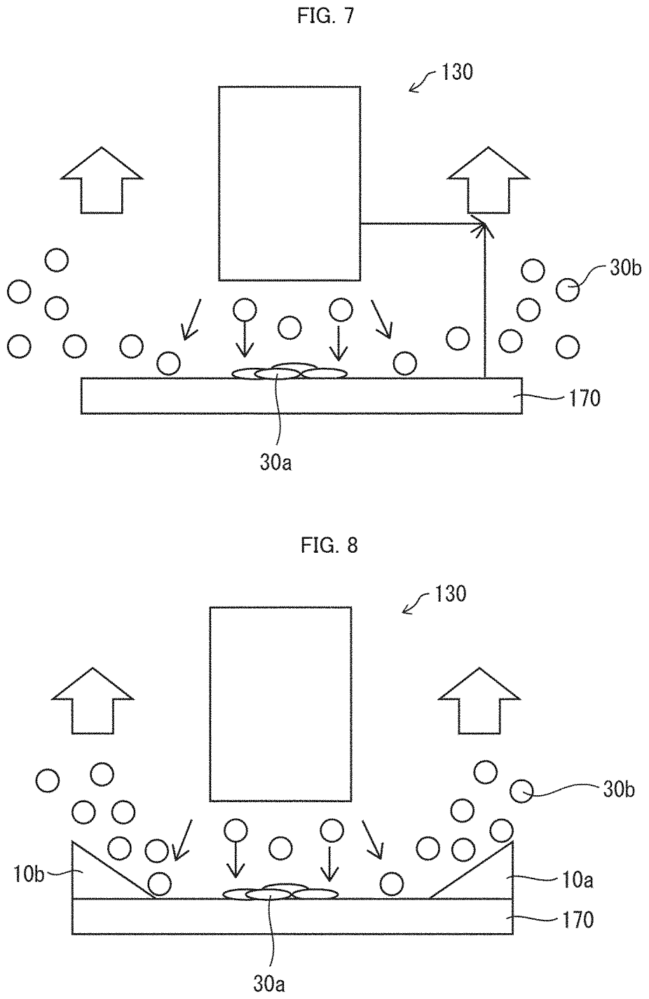

Next, a state in which the solid phase particles 30b are collected will be described with reference to FIGS. 5 to 9. In FIGS. 5 to 9, the attachment 1 and the collection section 20 are not illustrated for ease of viewing. The arrows illustrated in FIGS. 7 to 9 indicate directions in which the solid phase particles 30b are collected.

FIG. 5 is a view schematically illustrating a positional relationship between the spray nozzle 130 and the base material 170. D indicates a distance between the spray nozzle 130 and the base material 170. D is set to, for example, not less than 5 mm and not more than 15 mm. θ indicates an angle of the spray nozzle 130 with respect to the base material 170. In FIG. 5, θ is set to 90 degrees. Considering the film formation efficiency, θ is preferably not less than 75 degrees and not more than 90 degrees.

FIG. 6 is a view illustrating a state in which the solid phase particles 30b fly from the spray nozzle 130. Normally, in the cold spray method, the solid phase particles 30b account for approximately 97% of all of the solid phase particles, and the remaining solid phase particles (solid phase particles 30a) are involved in the film formation on the base material 170.

A carrier gas passage inside the spray nozzle 130 is such that fluid energy becomes lower toward an end portion of the carrier gas passage in a cross section of the spray nozzle 130 perpendicular to a direction in which the carrier gas passes. Thus, the solid phase particles that pass through the end portion of the carrier gas passage are likely to fly into the air without being involved in the film formation. FIG. 6 illustrates such a state.

The solid phase particles 30b move in the vicinity of the base material 170 under the influence of the carrier gas. In a region extending not less than 10 mm from the side surface of the spray nozzle 130 in the lateral direction (in a region such that L in FIG. 6 is not less than 10 mm), the solid phase particles 30b exhibit a high particle distribution in a region having a height of not more than 20 mm above the base material 170 (in a region such that H in FIG. 6 is not more than 20 mm). Hereinafter, the region in which the solid phase particles 30b exhibit a high particle distribution is referred to as a “high distribution region”.

FIG. 7 is a view illustrating a state in which the solid phase particles 30b are collected. Although not illustrated in FIG. 7, the openings 3a and 3b of the opening part 3 are preferably provided in the high distribution region. Positioning the openings 3a and 3b in the high distribution region enables enhancement of the efficiency in collecting the solid phase particles 30b.

FIG. 8 is a view illustrating a state in which the jigs 10a and 10b are provided on the base material 170. The jig 10a is located below the opening 3a, and the jig 10b is located below the opening 3b. The jigs 10a and 10b rectify the flow of the carrier gas sprayed through the spray nozzle 130 and guide the solid phase particles 30b toward the openings 3a and 3b. This makes it possible to further enhance the efficiency in collecting the solid phase particles 30b.

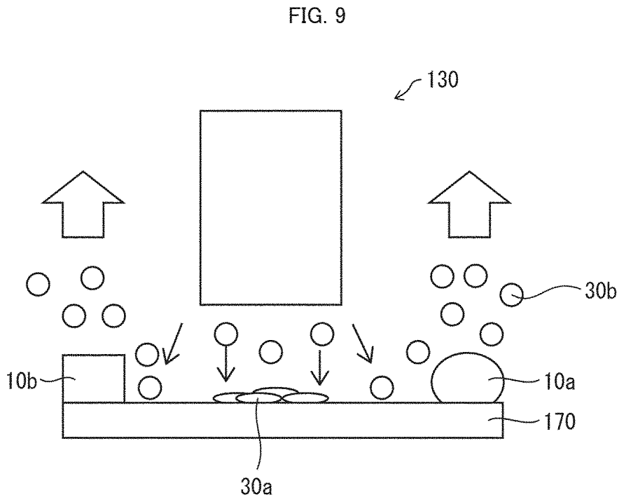

FIG. 9 illustrates an example of the shape of the jig 10. In FIG. 9, a cross section of the jig 10a is in the shape of a circle, and a cross section of the jig 10b is in the shape of a square. These are merely examples, and the shape of the cross section of the jig 10 may be, for example, a square shape, a rectangular shape, a triangular shape, a circular shape, or an arc shape. The size of the jig 10 only need be a size such that the jig 10 does not come into contact with the tip of the spray nozzle 130.

The jig 10 may be only one jig. However, the jig 10 preferably has two jigs 10a and 10b that extend along the direction in which the spray nozzle 130 moves. This makes it possible to further enhance the efficiency in collecting the solid phase particles 30b.

### Example

The following will show the efficiency in collecting the solid phase particles 30b which efficiency was calculated for each of the following cases (1) to (3):

(1) Case with no use of the jig 10: 9.2%
(2) Case illustrated in FIG. 3: 26.8%
(3) Case illustrated in FIG. 4: 24.3% (R=20 mm)

(Conditions)
The attachment 1 was used in all of the cases (1) to (3).
Opening center of the opening part 3:

10 mm away from the side surface of the spray nozzle 130 in the lateral direction and 20 mm high above the base material 170
Opening radius of the opening part 3: 7.5 mm
Number of openings of the opening part 3: two
Positions of the two openings: the two openings were located above the jigs 10a and 10b respectively in such a manner that the engagement part 2 was interposed between the two openings.
Airflow rate of the dust collector 21: 1.5 m³/min
Scanning speed of the spray nozzle 130: 5 mm/sec
Collection efficiency: calculated by “(collection amount/introduction amount)×100”

Each of the above values is a value obtained as a result of the operation performed once each.
Distance between the spray nozzle 130 and the base material 170: 10 mm
Angle of the spray nozzle 130 with respect to the base material 170: 90 degrees
Solid phase particles: nickel
Pressure of the carrier gas: adjusted so that the pressure of the carrier gas was not less than 70 PSI and not more than 150 PSI (not less than approximately 0.48 Mpa and not more than approximately 1.03 Mpa) at an exit of the tank 110.

Normally, in the cold spray method, approximately 97% of introduced solid phase particles become flying solid phase particles. The above case (1) is a case where only the attachment 1 was used. Even in this case, it was shown that 9.2% of the introduced solid phase particles were collected. From this result, it is found that the efficiency in collecting the solid phase particles enhances even in a case where the spray nozzle 130 is in motion. The higher the collection efficiency, the more resources and costs can be saved.

The above cases (2) and (3) are cases where the attachment 1 and the jig 10 were used. In these cases, it was found that the efficiency in collecting the solid phase particles further enhanced and was about three times that of the above case (1).

In the solid phase particle deposition device (cold spraying or aerosol deposition), there may be cases where the spray nozzle is in motion. Even in this case, as described above, the solid phase particle collection system 40, the solid phase particle collection device 25, and the attachment 1 in accordance with an embodiment of the present invention enable significant enhancement of the efficiency in collecting solid phase particles over the conventional techniques.

This effect is greater in a case where the cross section of the carrier gas passage inside the spray nozzle 130 is rectangular.

Specifically, in a case where the cross section of the carrier gas passage inside the spray nozzle 130 is rectangular, fluid energy becomes lower toward the end portion of the carrier gas passage in the cross section perpendicular to the direction in which the carrier gas passes. This tends to increase solid phase particles flying into the air.

In this respect, the attachment 1 in accordance with an embodiment of the present invention is set to the spray nozzle 130. Thus, even in a case where the cross section of the carrier gas passage inside the spray nozzle 130 is rectangular, it is possible to maintain the efficiency in collecting the solid phase particles. That is, the solid phase particle collection system 40, the solid phase particle collection device 25, and the attachment 1 in accordance with an embodiment of the present invention can be effectively used regardless of the shape of the cross section of the carrier gas passage inside the spray nozzle 130. Therefore, the solid phase particle collection system 40, the solid phase particle collection device 25, and the attachment 1 in accordance with an embodiment of the present invention can also solve the conventional problem that the flying of solid phase particles hinders mass production of products.

Nickel is used as the solid phase particles in the above cases (1) to (3), but, as a matter of course, a similar effect can be expected even when other solid phase particles are used.

Aspects of the present invention can also be expressed as follows:

An attachment in accordance with Aspect 1 of the present invention includes: an engagement part to be engaged with a spray nozzle of a solid phase particle deposition device; and an opening part connected to the engagement part and having at least one opening to be connected to a collection section that is configured to collect solid phase particles which are sprayed through the spray nozzle onto a base material and are not involved in formation of a film on the base material.

The above configuration makes it possible to efficiently collect flying solid phase particles even in a case where a spray nozzle of a solid phase particle deposition device is in motion.

In Aspect 2 of the present invention, the attachment in accordance with Aspect 1 above may be configured such that the opening part is integral with the engagement part.

The above configuration facilitates the production of the attachment and eliminates the need to manually connect the engagement part and the opening part to each other.

In Aspect 3 of the present invention, the attachment in accordance with Aspect 1 or 2 of the present invention may be configured such that the at least one opening includes two openings, and the two openings are provided such that the engagement part is interposed between the two openings.

The above configuration allows flying solid phase particles to be collected from directions which extend with the engagement part interposed therebetween, and thus makes it possible to enhance the efficiency in collecting solid phase particles.

A solid phase particle collection device in accordance with Aspect 4 of the present invention includes: an attachment set to a spray nozzle of the solid phase particle deposition device and having an opening; a collection section connected to the opening and configured to collect, via the opening, solid phase particles which are sprayed through the spray nozzle onto a base material and are not involved in formation of a film on the base material; and a guide member provided on the base material and configured to guide the solid phase particles toward the opening.

The above configuration brings about the same effect as the effect brought about by the attachment.

A solid phase particle collection system in accordance with Aspect 5 of the present invention includes: an attachment set to a spray nozzle of a solid phase particle deposition device and having an opening; a collection section connected to the opening and configured to collect, via the opening, solid phase particles which are sprayed through the spray nozzle onto a base material and are not involved in formation of a film on the base material; and a guide member provided on the base material and configured to guide the solid phase particles toward the opening.

The above configuration brings about the same effect as the effects brought about by the attachment and the solid phase particle collection device.

In Aspect 6 of the present invention, the solid phase particle collection system in accordance with Aspect 5 of the present invention may be configured such that the guide member extends along a direction in which the spray nozzle moves.

The above configuration makes it possible to maintain the efficiency in collecting the solid phase particles even in a case where the spray nozzle is in motion.

In Aspect 7 of the present invention, the solid phase particle collection system in accordance with Aspect 5 or 6 of the present invention may be configured such that the guide member is located below the opening.

The above configuration makes it possible to further enhance the efficiency in collecting the solid phase particles.

In Aspect 8 of the present invention, the solid phase particle collection system in accordance with Aspect 7 of the present invention may be configured such that an opening center of the opening is positioned at a position that is not less than 5 mm and not more than 30 mm away from a side surface of the spray nozzle in a lateral direction and that is at a height of not less than 5 mm and not more than 20 mm above the base material.

According to the above configuration, enhancement of the efficiency in collecting the solid phase particles can be expected.

In Aspect 9 of the present invention, the solid phase particle collection system in accordance with any one of Aspects 5 to 8 of the present invention may be configured such that the guide member is in a shape of a rectangle, a square, a triangle, a circle, or an arc in cross section perpendicular to a direction in which the spray nozzle moves.

The above configuration makes it possible to efficiently collect flying solid phase particles.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: attachment
2: engagement part
3: opening part
3a, 3b: opening
30a, 30b: solid phase particle
10, 10a, 10b: jig (guide member)
20: collection section
21: dust collector
22: hose
25: solid phase particle collection device
40: solid phase particle collection system
100: cold spray device
110: tank
120: heater
130: spray nozzle
140: feeder
150: base material holder
170: base material

1. An attachment comprising:
an engagement part to be engaged with a spray nozzle of a solid phase particle deposition device; and
an opening part connected to the engagement part and having at least one opening to be connected to a collection section that is configured to collect solid phase particles which are sprayed through the spray nozzle onto a base material and are not involved in formation of a film on the base material.

2. The attachment according to claim 1, wherein
the opening part is integral with the engagement part.

3. The attachment according to claim 1, wherein
the at least one opening includes two openings, and
the two openings are provided such that the engagement part is interposed between the two openings.

4. A solid phase particle collection device for use in a solid phase particle deposition device, comprising:
an attachment set to a spray nozzle of the solid phase particle deposition device and having an opening; and
a collection section connected to the opening and configured to collect, via the opening, solid phase particles which are sprayed through the spray nozzle onto a base material and are not involved in formation of a film on the base material.

5. A solid phase particle collection system, comprising:
an attachment set to a spray nozzle of a solid phase particle deposition device and having an opening;
a collection section connected to the opening and configured to collect, via the opening, solid phase particles which are sprayed through the spray nozzle onto a base material and are not involved in formation of a film on the base material; and
a guide member provided on the base material and configured to guide the solid phase particles toward the opening.

6. The solid phase particle collection system according to claim 5, wherein
the guide member extends along a direction in which the spray nozzle moves.

7. The solid phase particle collection system according to claim 5, wherein
the guide member is located below the opening.

8. The solid phase particle collection system according to claim 7, wherein
an opening center of the opening is positioned at a position that is not less than 5 mm and not more than 30 mm away from a side surface of the spray nozzle in a lateral direction and that is at a height of not less than 5 mm and not more than 20 mm above the base material.

9. The solid phase particle collection system according to claim 5, wherein
the guide member is in a shape of a rectangle, a square, a triangle, a circle, or an arc in cross section perpendicular to a direction in which the spray nozzle moves.
